(19) United States
(12) Patent Application Publication
(10) Pub. No.: US 2008/0106368 A1
(43) Pub. Date: May 8, 2008

(54) Secure storage facility

(76) Inventor: Eberto A. Vitier, Coral Gables, FL (US)

Correspondence Address: AKERMAN SENTERFITT, P.O. BOX 3188, WEST PALM BEACH, FL, 33402-3188, US

(21) Appl. No.: 11/552,083

(22) Filed: Oct. 23, 2006

(51) Int. Cl. G05B 19/00

(52) U.S. Cl. 340/5.5; 340/521; 340/540

(57) ABSTRACT

A secure storage facility has storage bays for rental in a building having reinforced walls and partitions, impact and explosion resistant security doors and a limited access control room from which all security doors are remotely locked and unlocked and are monitored with video and audio communications, each storage bay having an independently adjustable temperature, humidity and lighting system, and sensors within for providing environment information to the control room, and the facility having a vehicle loading area and a vehicle security zone in which a vehicle can be inspected before access is allowed to the loading area.

This invention is for a secure storage facility for valuable assets in which access and physical environment are controlled to provide maximum security and preservation of assets.

### BACKGROUND

Individuals and corporations who maintain valuable collections, either as owners or as escrow agents, are faced with the dual tasks of keeping the collections secure from theft and intentional or accidental destruction, and of maintaining and preserving the collections within a physical environment that minimizes or eliminates deterioration or wasting of individual items within a collection. Traditionally, storage facilities for such collections have been dedicated to one or the other of those tasks, with the result that collections for which security from theft or destruction has been paramount have not been well protected against the natural elements. Conversely, where the physical environment is regulated to preserve items in a collection, such as valuable paintings or antiques, they are seldom provided with a maximum of security against theft, vandalism, or intentional or accidental destruction.

Such complete protections are found, if at all, in government or well-endowed foundation-sponsored museums and institutions, such as the Louvre, the British Museum, the National Gallery of Art, and other institutions in which extraordinary funding is adequate for both security and preservation. What is needed is a facility that provides both security and preservation for individuals and corporations who own, or are escrow agents for, valuable collections not suitable for display or maintenance in the large institutions.

### SUMMARY OF THE INVENTION

The present invention is a secure facility that may be multi-level, in which access is limited and controlled, and individual environments are adjustable in accordance with the type of asset or object being stored in secure rooms. Access to the facility, and access to discrete security zones within the facility, are controlled exclusively from a control room. All access requires a positive action to be taken from the control room, and access is not granted until positive verification of the individual seeking access has been made.

A primary feature of the facility is the liberal use of security doors. Security doors are made of a strong metal or other durable substance, are fireproof, impact and explosion resistant, and have multiple locking points that are controlled remotely from the control room. Security doors may also be watertight if desired. Each security door has a video camera or other identification device, and two way voice communications to the control room from either side of the door. Security doors are used primarily to create separate security zones and to provide access to the storage bays within the facility. Security doors are always locked shut, and can be opened only upon remote activation from control room personnel. Sensors at each security door provide information to the control room regarding the position and state of the door as being open, closed, or closed and locked. Upon verification that an individual is authorized to enter the limited area controlled by the door, a control room operator will activate an unlocking mechanism so that the door may be opened. As an optional security measure, all security doors may be connected via a computer, and programmed to ensure that, before any door is unlocked, all other doors within the security zones on either side of the operative door, are locked. By so doing, positive control access will be assured as it will be nearly impossible for adjacent doors to be held open to permit unrestricted passage through more than one security zone at a time.

In addition to security doors, the facility may also have controlled doors that may be opened only upon remote activation from the control room. As with security doors, controlled doors also have sensors to provide information to the control room about the door's state as open, closed, or closed and locked. Such doors need not provide the same physical integrity as security doors, but are a secondary means of limiting access and further promoting security against low-grade threats such as minor crimes of opportunity.

In the preferred embodiment, there are two walk-in entrances and one drive in area with a truck loading dock. There is an additional walk-in entrance leading only to the equipment area, and which is intended only for the use of workmen who may be working on equipment such as the elevators, the air conditioning, and the like. However, there is no direct access into the facility from the equipment room area. All entrances, including the equipment room entrance, are secured, and can be opened from the control room upon the presentation of proper identification and verification. Video cameras and other state of the art equipment may be used to verify identity.

A first walk-in entrance leads to a lobby where a receptionist is situated behind a security wall having a small aperture or glass opening through which business can be conducted and which protects the receptionist from assault or physical intimidation by persons in the lobby. There are security doors from the outside into the lobby, and between the lobby and an interior vestibule to prevent unauthorized persons from entering the lobby or the vestibule. From the vestibule, one can access the office manager's office, from which there is access to the receptionist's office; or, upon positive authorization, a person may be admitted to stairs leading only to the control room on the second floor.

A second walk-in entrance provides access to the first and any upper floor storage areas. This entrance does not require a person to enter the lobby, and is suitable for admitting persons who are authorized to be inside the facility, and whose admittance will be allowed upon the presentation of proper identification. Such individuals may include security employees or staff, or persons who have rented storage space within the facility. A pair of security doors must be transited before one can gain entry into the storage area. The double entry door configuration provides security against unauthorized persons entering from the street while a confederate holds open an inner security door leading to the storage area.

A primary feature of the facility is that no person will be given access into the premises unless and until they have been identified and have received positive authorization to enter the facility. For vehicular access, a double entry vestibule takes the form of a secured transition area in which vehicles may be searched before passage into the facility will be allowed. For most vehicles, a large x-ray machine may be used to view vehicle interiors, hidden spaces, or sealed packages without the requirement of stripping panels or opening every compartment or package. The x-ray may be enhanced as desired with other state of the art detection equipment, including scales, odor detection and analysis apparatus, sonic devices, and the like, the goal being that no unauthorized persons and no dangerous or explosive substances may be admitted into the facility through the vehicular access area. Upon exiting the facility, similar procedures may be used to ensure that nothing is being removed from the facility unless prior notification has been given to the control room and authorization to remove specific items has been obtained.

When a vehicle is in the loading area it must be accompanied by at least one facility staff member whose job will be to monitor the loading or unloading of the vehicle. From the loading area, a security door provides access to the storage rooms on the ground floor. For multi-story facilities, an elevator opens onto the loading area. The elevator is also equipped with security doors, and a staff person will generally be required to operate the elevator, or to ride and observe that it stops only on floors appropriate to the person using it. The elevator may be controlled from the control room, and will stop only on floors permitted by the control room. For persons on an upper floor intending to use the elevator, access to the elevator may be had only following approval from the control room.

Persons visiting the facility for the first time may be admitted into a lobby and held there until initial processing or registration can be performed. If an individual is a visitor or potential buyer of goods being maintained in the facility, that person may be registered and then sent to the external entrance to be met there by a security staff member who will accompany them to a show room for the sole purpose of viewing items that may be brought or displayed there. A similar level of access may be provided for repair persons who are hired to work on equipment located at the facility, and who have a need to enter the storage or security areas. Utility rooms for housing electrical equipment, air conditioning equipment, a standby generator, and elevator equipment, are located in a single area of the facility that is isolated from the storage areas. Access to the utility rooms is controlled from the control room, and the higher level of security provided by security doors and pre-registration of the repairman will normally be required. The utility area is maintained within a separate and discrete security zone from the rest of the facility, and repairmen will be given access into the storage areas only when such access is necessary for the proper repair or maintenance of one of the subsystems. Registration for service personnel will also be a prerequisite for entrance to the facility.

The building shell is constructed of reinforced concrete or a similarly impermeable construction material. There will be a number of fire exits in accordance with local fire codes. Fire exits open into an outside area that is surrounded by a high fence around the perimeter of the facility that has only one or two gates for external exit. These gates are under direct or electronic visual observation from the control tower, and their opening may also be controlled by the control tower, if desired. The area within the fence includes holding areas where persons may be retained during fire alarms or non-life threatening emergencies.

In addition to a main lobby to receive persons entering the facility from the street, the facility also includes a reception area and a manager's office that are accessible only through the lobby. A security door from the lobby to a secure corridor provides access to the manager's office and reception area, and leads to another security door that isolates the control room.

The storage areas are compartmentalized in groups, and security doors are used to divide each section from the others. Storage rooms are windowless, and each storage room is independently secured with a double locking system in which the lessee can operate one lock using a PIN or a key, and the other lock is operated from the control room. Both locks must be operated before the door to a storage room may be opened. In addition, each room has its own alarm system that is controlled from the control room. The renter can enter the space using a personal PIN or key, but must first receive permission from the control room and have the alarm de-activated.

Each storage room has an individual climate control that is used to establish both the temperature and humidity within the storage room. The requirement for individually controlled environments may also require specialized air conditioning units or controller systems. Lighting within individual storage rooms can also be regulated as to color or hue and intensity, so that, for example, light sensitive articles may be stored with a minimum of deterioration.

One or more show rooms are maintained in the facility and, generally, are able to have their environments set or modified in the same way as individual storage rooms. When a unit lessee wishes to show stored items to a prospective buyer, the items will be brought to one of the show rooms and the prospective buyer will then be allowed into the room to view the items. The prospective buyer will not, however, be permitted to enter any other storage areas.

The control room has facilities to establish and maintain security at every security door, at the walk-in and vehicular entry areas, at the fire exits, at the gates through the external fence, in the elevators, in the show rooms, and in the access areas to the manager's office and to the control room. The control room also has equipment to visually monitor and verbally communicate with persons in each of the security areas, and to conduct a non-intrusive vehicular search when a vehicle is entering or leaving the facility. The control room also has the capability of monitoring the environment within storage rooms, and to adjust the environment at the lessee's request.

### BRIEF DESCRIPTION OF THE DRAWINGS

FIG. 1 depicts an embodiment of the invention showing a representative ground floor plan incorporating the features of the invention.

FIG. 2 is an embodiment of a representative upper-story floor plan of the secure storage facility of this invention.

### DETAILED DESCRIPTION OF THE PREFERRED EMBODIMENTS

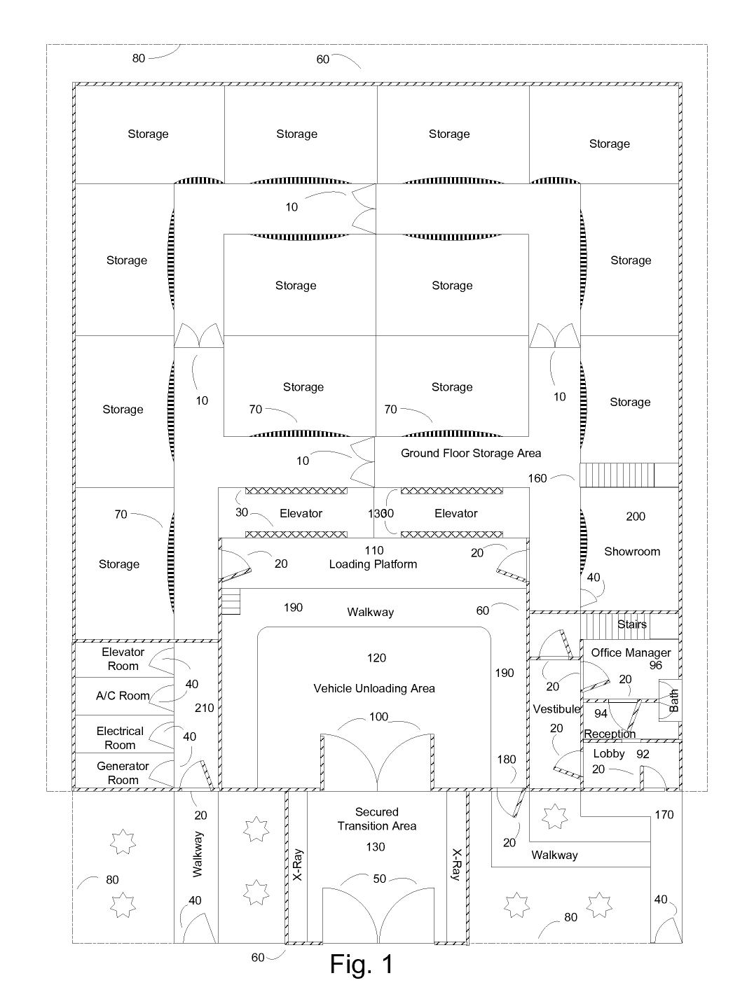

In FIG. 1, a number of fire doors 10 are shown at various locations on the ground floor, and are intended to segregate any areas in which a fire may occur. These fire doors meet the local fire codes, but are not necessarily required to perform the function of security doors. Fire doors 10 will normally be left open, and will be closed automatically upon the occurrence of a fire alarm.

Security doors 20 are also shown in FIG. 1 and serve to isolate separate security zones. In FIG. 1, security zones are created by reinforced walls and partitions 60, which are shown in cross-hatch. An individual can enter a security zone only through a security door 20. Prior to entry, the individual must be identified and positive authorization must be obtained from a control room 150.

Security doors 20 are fireproof, and are also impervious to impact, resistant to explosion, and may also be watertight. Security doors have multiple locking points to provide strength against being forced, and will always be closed unless remotely activated to the open position by control room personnel. The position of each security door is actively monitored, and no security zone may have two security doors that are open at the same time. An individual passing through a security door 20 must be in communication with the control room 150 and must be positively identified before the door may be opened. Such communication will normally include at least a one-way video and a two-way audio communications link. Where extreme security is desired, security door activation may also require unlocking with a physical key in the possession of a guide or monitor and, in addition, may require remote activation.

In addition to security doors 20, access may also be controlled by control doors 40. Control doors are also operable from the control room, but maintain a lower level of security and, if desired, have locking systems that may be deactivated such that they can be opened normally by visitors and service personnel.

There are two entrances to the facility: One entrance 170 leads through the lobby 92, and provides access only to the administrative areas consisting of the office manager's office 96, the reception area 94, or the control room 150. The second entrance 180 provides access to the storage and showroom areas, but does not permit access to the administrative areas. To pass between these two areas, one must exit the facility and reenter through a different door.

In FIG. 1, an individual wishing to go to the office manager's office 96, or the reception area 94, or the control room 150, will enter the facility at the lobby 92 after passing through a perimeter fence 80 and a control door 40. Upon entering the lobby 92, the individual will communicate with a receptionist who is situated within a safe area that cannot be directly accessed from the lobby. The receptionist 94 is in direct communication with the control room 150 and also with the Office Manager 96. Although the lobby area 92 has minimal security, a security door 20 separates the lobby 92 from the administrative areas 94, 96 and 150, and those areas can be accessed only upon authorization given from the control room 150. Access to the administrative areas 94, 96, 150 will be strictly limited to persons having a need to be in one of the administrative areas and, because all of the essential functions of the facility are under the control of administrative and control room personnel, those areas will have the highest level of security against unauthorized access.

Access to the storage areas is gained through an external security door 180 located upon an external walkway from the street. Upon an individual's being identified and granted authorization to enter the facility, a pre-opening check will be made to determine whether all other doors into the entry security zone 190 are closed and locked; and, if they are, security door from the external walkway will be opened. The pre-opening check can be made by a control room operator, or can be a computerized function whereby door position sensors constantly provide information regarding the status of a security door as being open or closed and locked. Only when all other security doors into a security zone are closed and locked will any given door into that security zone be opened.

Upon the individual's entering the entry security zone 190, the external security door 20 will close and the individual may then proceed within the vehicle unloading area 120 to one of the security doors 20 leading to the storage area. Upon being positively identified from the control room, the next security door will be opened, and the individual may pass through into the storage area.

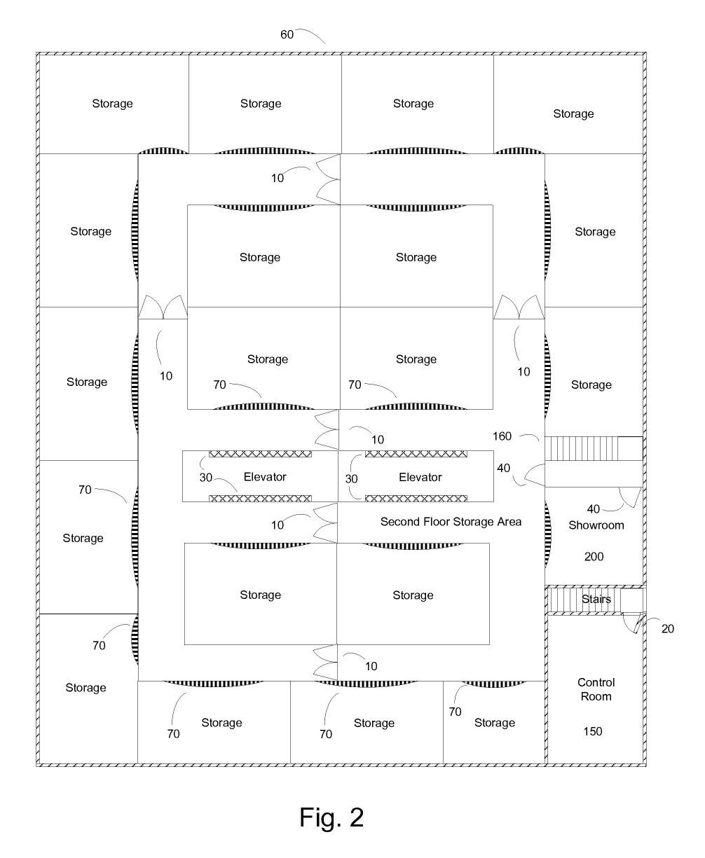

Storage bays are maintained on all levels of the facility depicted in FIGS. 1 and 2. If the individual is going to a storage bay on the ground floor, he may proceed directly to the Ground Floor Storage Area. Upon reaching this area, the individual may proceed to a storage bay on the ground floor or, if the bay he is going to is on the second floor, may take an elevator or the stairway to the second floor to visit the appropriate storage bay. Each storage bay is secured by a door 70 which may be locked by conventional means, and may be accessible to the individual by means of a key or combination possessed only by the individual. Alternatively, or in addition, storage bays may also be placed under the control of control room personnel, and access to a specific bay may be denied unless the individual is identified and authorized to enter the bay.

If the individual should be going to a bay on an upper floor, access is provided by means of an internal stairway 160 from the ground floor, or by elevator. If internal stairs 160 are taken, the individual will proceed up the stairs to the second floor landing, shown on FIG. 2, and will again be required to be identified and authorized to enter the second floor storage area through a control door 40.

If an elevator should be used to provide access to the second floor, the individual must first enter the ground floor storage area, where the elevator may be called. Elevator doors 30 are controlled from the control room 150, and are subject to the rules that apply to security doors. Before an elevator door 30 may be opened from the outside, it is necessary that all other security doors opening into the ground floor security area be closed and locked. For larger facilities in which there is a high level of activity, this requirement may be met by installing a number of internal security doors within the storage area to provide for the isolation of smaller spaces than the entire ground floor storage area. In addition, although the elevator may have multiple doors, only one door may be open at a time. Under circumstances in which an elevator may malfunction, or an elevator user may attempt to open an elevator door using emergency means, the opening of an elevator door 30 may be delayed until all other security doors within the security zone into which the elevator door will open have been closed and locked. All elevator functions, except emergency functions available from within the elevator cab, may be controlled concurrently or solely by control room personnel. This requirement will prevent individuals from gaining unauthorized access to security zones, and will assure that the only persons within a security zone are those who have been given access by control room personnel.

Where items being brought into or taken out of the storage facility will be transported by automobile or truck, a vehicular entrance is provided. The vehicular entrances are protected by large outer vehicle doors 50. Normally, outer vehicular doors 50 will remain closed until a vehicle requires access. As with security doors 20, an outer vehicular door 50 can never be opened while another door into the same security zone is open.

In FIG. 1, outer vehicular doors 50 open from the street into a secured transition area 130. Sensors are provided at either side of the secured transition area 130 to assist in the detection of hazardous, noxious, explosive, or otherwise dangerous cargo prior to the vehicle's entering the storage facility. In FIG. 1, x-ray inspection is provided. However, other sensors may be employed at various locations throughout secured transition area, and any cargo inspections deemed necessary or prudent may be carried out within this area before the vehicle is cleared for entry into the vehicle unloading area within the facility. Once a vehicle has been cleared to enter the facility, outer vehicle doors 50 will be closed, and inner vehicle doors 100 may be opened. Inner vehicle doors 100 have the same characteristics as security doors 20 in that they are resistant to impact, explosion, and fire. Before inner vehicle doors 100 are opened, however, a check will be made to determine that elevator doors 30 are closed and that all other security doors 20 opening into the vehicle unloading area 130 are also closed and locked. A vehicle driver will normally be required to be identified before further access will be granted. Access to the ground floor storage area is through a security door 20 connecting the loading platform 110 and the ground floor storage area. Access to the second floor storage area is provided by an elevator or internal staircase 160.

As shown in FIGS. 1 and 2, on each floor there is provided a showroom 200 within the storage security zone. The showroom is a place where valuable items being stored in the facility may be shown to visitors and potential buyers without exposing the valuables to the outside environment. Once the goods to be shown have been moved from their storage bay(s) into a showroom 200, the showroom bay door can be closed and secured, and visitors can then be admitted through a separate door, which, optionally, may be a security door.

As shown in FIG. 1, a lower level of security is provided for equipment rooms 210 that house air conditioning, electrical, generator, and elevator equipment. Although those rooms have some protection through the use of control doors 40, the need for service personnel to make frequent trips to and from their service vehicles makes it inconvenient to require them to use security doors for each ingress into or egress from the facility. Therefore, although the equipment rooms 210 are maintained adjacent to the facility, and within a secure perimeter 80, they are not subject to the same level of security as the storage areas. In the event that a service person requires access into a security zone, access is provided through the external entrance 180 that is used for persons authorized to enter the storage areas.

A secure perimeter 80 is also provided for the facility by means of a fence or other enclosure surrounding the facility. In the event of fire or other catastrophe, emergency exits (not shown) must be provided as required by local fire codes. A tall fence that cannot be easily scaled surrounds the facility, and permits persons to exit the building and reach a safe open area without allowing them to leave the premises. One or more gates through the fence (not shown) can be monitored in times of emergency, or access to other holding areas may be given, depending upon the nature and severity of the emergency.

There are a number of systems installed within the storage areas and individual storage bays to maintain a proper environment for delicate or otherwise degradable stored items. These systems are monitored from the control room 150, and appropriate corrective or alarm measures may be taken whenever environmental parameters exceed what is appropriate for the storage bay. Controlled parameters include air temperature and humidity, degree and cycles of lighting, dust particulate level in the air, oxygen concentration, and the like. A standby generator ensures that electrical power will be maintained, even under circumstances in which public power facilities have become inoperable. By balancing these, and other, parameters, the most favorable environments can be attained and maintained, making the storage facility of this invention a safe and secure place to store valuables and have them retain their qualities and characteristics.

Although FIGS. 1 and 2 depict specific embodiments of a floor plan, it will be understood that these figures are conceptual, and that other embodiments may be envisioned that utilize the concepts of the invention in other configurations. Having described the invention in detail, it will be obvious that such other embodiments and configurations will fall within the scope of the invention, which is limited only by the claims that follow.

I claim:

1. A secure storage facility having secure storage areas for rental comprising:
a building comprising an adjustable building environmental system for controlling temperature, humidity, and lighting of common areas within said building, said building having exterior walls comprising concrete and reinforced steel sufficient to withstand explosions and impacts of predetermined intensity;
said building comprising a plurality of security doors and secure areas including at least a control room, an administrative area, a utility and maintenance area, a vehicular loading area, a viewing room, and at least one storage area comprising storage rental bays,
each said security door being impact and explosion resistant and having one or more security locks that may be actuated remotely from said control room, each said security door having a sensor whereby the status of said door as being open, closed, or closed and locked may be remotely determined from said control room, a video and audio communications terminal being situated on either side of each said security door, said video and audio communications terminals being in two-way electronic communication with said control room;
said administrative area further comprising an entrance lobby, a reception office, a managerial office, and first and second security vestibules, said first and second security vestibules comprising a passageway to said control room,
said lobby having an external door to provide pedestrian ingress from outside said building, said lobby being separated from said first security vestibule by a security door and being separated from said reception office by an impact and explosion resistant wall, said lobby and said reception office being in audio communication with each other and with said control room;
said managerial office being separated from said first security vestibule by a lockable door and being separated from said reception area by a lockable door,
said first security vestibule being separated from said second security vestibule by a security door, said second security vestibule comprising a passageway to said control room;
said control room being separated from said second security vestibule by a security door and having walls separating said control room from the remainder of said facility, said control room walls being reinforced to withstand explosions and impacts within predetermined limits, said security door having at least one independent lock operable only from within said control room;
said storage area comprising a plurality of secure storage bays, each said storage bay having a lockable door opening into one of a plurality of passageways connecting multiple storage bays, each said storage bay having an independently adjustable environment, said adjustable environment comprising adjustable temperature, humidity and lighting controls and having sensors within said storage bay for providing environment information to said control room;
each said secure storage bay having an independently configured and remotely monitored security system, each said independently configured security system having sensors to provide an alarm in the event of fire, smoke, or unauthorized entry;
said plurality of secure rooms being connected by passageways within said building,
said plurality of passageways having internal doors for isolating portions of said passageways, each said internal door being remotely operable from said control room, said passageway doors being substantially watertight and able to withstand fire and concussive overpressure within predetermined limits when closed;
a vehicle loading area comprising a loading dock within said building and having an external entrance, said vehicle loading area being separated from said storage bays by one or more security doors;
said vehicle security zone having inner loading area doors and outer loading area doors, said inner and outer loading area doors being remotely lockable and operable from said control room, said inner and outer loading area doors when locked being able to withstand fire, concussive overpressure, and physical impact within predetermined limits;
said inner and outer loading area doors defining said vehicle security zone and being interoperably connected such that said outer loading dock doors and said inner loading dock doors cannot be open simultaneously;
said vehicle security zone being separated from said vehicle loading area by said inner loading area doors and comprising a holding area into which a vehicle from an external area may be admitted for examination of the contents before the vehicle is authorized to enter said vehicle loading area;
said utility and maintenance area comprising a passageway and a plurality of utility and maintenance rooms wherein environmental and mechanical systems serving said facility are located, said utility and maintenance area having no connecting passageway to said control room, said administrative area, said vehicle loading area, or said secure areas, said utility and maintenance area having ingress from outside said facility through a door having remotely operable locks, said remotely operable locks being controlled from said control room;
said viewing room having a lockable door opening onto one of said passageways in said at least one said storage area;
said building having an emergency power generator for providing electrical power to said facility during local power outages.

2. A secure storage facility as claimed in claim 1, further comprising one or more emergency exits from said building leading to undeveloped land adjacent to at least a portion of said building, said undeveloped land having a fence to define an emergency holding area adjacent said building, said fence providing a barrier to human traffic and having one or more controlled exits whereby individuals leaving said emergency holding area may be searched prior to exiting said holding area.

3. A secure storage facility as claimed in claim 1, further comprising electronic identification means located at each external entrance to said facility and located at either side of each said security door.

4. A secure storage facility as claimed in claim 1 wherein said vehicle security zone further comprises x-ray means for inspection of vehicle contents.

5. A secure storage facility as claimed in claim 1, further comprising computer means for controlling said security doors whereby said computer means permits a first of said security doors to be opened only after determining that every other one of said security doors located within the areas adjacent said first security door is closed and locked.
